(19) United States
(12) Patent Application Publication
(10) Pub. No.: US 2025/0183660 A1
(43) Pub. Date: Jun. 5, 2025

(54) METHOD AND SYSTEM FOR MONITORING A VOLTAGE GRID, METHOD FOR TRAINING AN ARTIFICIAL INTELLIGENCE TO PREDICT A FUTURE STATE OF A VOLTAGE GRID, COMPUTER PROGRAM, AND COMPUTER-READABLE DATA CARRIER

(71) Applicant: DEHN SE, Neumarkt i.d.OPf. (DE)

(72) Inventor: Christian Ferstl, Neutraubling (DE)

(21) Appl. No.: 18/842,572

(22) PCT Filed: Mar. 3, 2023
(86) PCT No.: PCT/EP2023/055481

§ 371 Date: Aug. 29, 2024

(30) Foreign Application Priority Data
Mar. 4, 2022 (DE) 102022105138.2

(51) Int. Cl. H02J 3/00; H02J 13/00

(52) U.S. Cl. CPC H02J 3/0012; H02J 13/00002; H02J 2203/10; H02J 2203/20

(57) ABSTRACT

A method of monitoring a voltage grid (12) is described, in which at least a first characteristic parameter is acquired at a first point in time and the first characteristic parameter u of the voltage grid (12) is acquired at a second point in time. The first characteristic parameter acquired at the first point in time and the first characteristic parameter acquired at the second point in time are fed into a processor unit (16) which processes the first characteristic parameter acquired at the two points in time together such that a future state of the voltage grid (12) is predicted on the basis of the first characteristic parameter acquired at the at least two different points in time. The predicted future state of the voltage grid (12) is output. In addition, there are described a method of training an artificial intelligence (24), a system (10), a computer program (18), and a computer-readable data carrier (20).

The invention relates to a method of monitoring a voltage grid. The invention further relates to a method of training an artificial intelligence for predicting a future state of a voltage grid. Furthermore, the invention relates to a system for monitoring a voltage grid, to a computer program, and to a computer-readable data carrier.

In this day and age, voltage grids are already considerably more volatile than has been the case in the past. This is due, inter alia, to the constantly increasing but fluctuating demand for energy and the progressive feed-in of renewable energies into the supply grid, which also occurs more irregularly. In addition, it can be assumed that the voltage grids will become even more volatile in the future, since the proportion of fed-in renewable energy will continue to increase while at the same time the voltage grids will be under greater load in the short term, for example because of the increase in electric mobility, especially in the automotive sector. However, the increase in volatility of the voltage grids leads to a decrease in grid quality, which may result in an increase in disruptions and even outages, which needs to be avoided.

For grid operators and for electricity users or electricity customers, it is therefore of interest already now to record the current grid status of the voltage grid, with past grid-disturbing events being analyzed in order to identify any points of disturbance. To this end, smart devices are known, such as the DEHNrecord, which acquires and analyzes a characteristic parameter of the voltage grid in order to determine the current grid quality of the voltage grid. Smart devices of this type are thus employed, for example, at the grid operator's or the electricity user's or electricity customer's premises.

EP 3 336 995 A1, for example, discloses a method and a system by means of which a current or instantaneous operating state of a sub-grid of an energy supply grid is determined.

In this respect, the voltage grid that is analyzed may be the local voltage grid, which is also referred to as a building grid, i.e. the voltage grid at the customer's premises, for example a private household or an industrial building. In other words, a low-voltage grid is monitored.

However, due to the volatility of voltage grids increasing in the future, the analysis of the instantaneous grid quality will presumably no longer be sufficient, so that an improved analysis and monitoring of the voltage grid is required.

It is the object of the invention to provide a way that allows the voltage grid to be monitored cost-effectively and with high quality.

The object is achieved according to the invention by a method of monitoring a voltage grid, comprising the steps of:
acquiring at least a first characteristic parameter of the voltage grid at a first point in time;
acquiring the first characteristic parameter of the voltage grid at a second point in time that is different from the first point in time;
feeding the first characteristic parameter acquired at the first point in time and the first characteristic parameter acquired at the second point in time into a processor unit, which processes the first characteristic parameter acquired at the first point in time and the first characteristic parameter acquired at the second point in time together such that a future state of the voltage grid is predicted on the basis of the first characteristic parameter acquired at the at least two different points in time; and
outputting the predicted future state of the voltage grid.

The fundamental idea of the invention is that a future grid quality is estimated or predicted on the basis of historical and/or current data of the voltage grid, so that the grid operator of the voltage grid and/or an electricity customer/electricity user is enabled to identify future disturbances at an early stage. In other words, the grid operator and/or the electricity customer/electricity user can anticipate a point in time of an upcoming grid disruption and the intensity thereof. This allows appropriate countermeasures to be initiated in order to avert the upcoming grid disruption, to at least reduce its intensity or generally to minimize the impact of the upcoming grid disruption on certain areas.

The invention is based on the finding that, due to volatile voltage grids, it is often more decisive for the grid operator and/or the electricity customer/electricity user how the voltage grid will behave in the future with regard to its grid quality (grid state) than the current grid state, which can no longer be reacted to in any case. In fact, looking into the future makes it possible to initiate suitable measures in good time to counteract the predicted grid disruption, that is, the deteriorated state of the voltage grid.

In other words, this means that the grid operator and/or the electricity customer/electricity user is enabled to design the voltage grid to be more resilient to disruptions to be anticipated in the future.

The future state of the voltage grid can be predicted for the next few hours, days or weeks, so that the grid operator and/or the electricity customer/user is given sufficient time to initiate any countermeasures in good time so that they can still counteract a predicted disruption or deterioration.

The countermeasures to be taken may, for example, consist in avoiding further loads in a predicted phase of weakness of the voltage grid, thereby ensuring fail-safe operation of devices and/or machines the operation of which should not be disrupted. In this respect, the countermeasure may consist in disconnecting any machines or devices that are not absolutely necessary from the grid during the predicted phase of weakness in the voltage grid or in not connecting them to the voltage grid in order to reduce the load or not to increase it further.

Generally, the voltage grid may be a local grid, also referred to as a building grid, which is associated with a private household or an industrial building. The voltage grid may thus be a low-voltage grid, for example a building grid that is connected to a supply grid.

For the prediction, the first characteristic parameter may be acquired multiple times, i.e. at least at two different points in time, with the values of the first characteristic parameter acquired at the different points in time being fed into the processor unit for evaluation. It can thus predict the future time profile from a time profile of the first characteristic parameter of the voltage grid which was recorded in the past and which can extend up to the present. The future time profile may relate here to the first characteristic parameter, so that the future time profile thereof is predicted, which corresponds to the predicted future state of the voltage grid.

The first characteristic parameter alone allows a characterization of the current state of the voltage grid. Since the processor unit jointly evaluates at least two values of the first characteristic parameter which were acquired at different points in time, it is now possible to predict future states of the voltage grid accordingly, something which would not be possible on the basis of the evaluation of a single characteristic parameter alone.

In particular, use is made here of correlations between the at least two different points in time of the first characteristic parameter, on the basis of which a future state of the voltage grid is reliably predicted.

In this respect, correlations can be inferred based on the common evaluation of the same measurand at different points in time.

A second quantity may additionally be used, which is different from the first parameter. The second quantity may be a separate quantity that is not necessarily a parameter of the voltage grid.

The second quantity may be obtained from a database in order to include, for example, environmental data, in particular weather data, time data (working day, weekend, public holiday, day and/or night) or usage data of systems in the surrounding area, for example a timetable for trains or usage data of electric charging systems in the surrounding area.

In this respect, the second quantity can be used to obtain an item of information that comprises a difference between the two different points in time. In particular, this allows a relationship to be determined between two different values of the first characteristic parameter which were acquired at the two different points in time.

But the second quantity may also be a second characteristic parameter of the voltage grid, which is different from the first characteristic parameter of the voltage grid.

In particular, the development over time of the first characteristic parameter, which has been acquired at least at the first point in time and at the second point in time, can be evaluated together with the second quantity, which is different from the first characteristic parameter of the voltage grid. In this respect, a time series of the first characteristic parameter can be evaluated together with further data, for example data obtained from a database such as weather data, time data and/or usage data of systems in the surrounding area.

Therefore, a data fusion of two different quantities may be available, which allows a look into the future of the state of the voltage grid. In other words, when the two different quantities are processed together, a correlation between these quantities is made use of, which allow conclusions to be drawn about the future behavior of the voltage grid. This allows the future state of the voltage grid to be predicted accordingly.

Basically, the method of monitoring a voltage grid may also comprise the steps of:
acquiring at least a first characteristic parameter of the voltage grid, in particular at a first point in time and a second point in time;
acquiring at least a second characteristic parameter of the voltage grid, which is different from the first characteristic parameter of the voltage grid;
feeding the first characteristic parameter, in particular the values of the first characteristic parameter acquired at the first point in time and at the second point in time, and the second characteristic parameter into a processor unit, which processes the two different characteristic parameters together such that a future state of the voltage grid is predicted on the basis of the two different characteristic parameters; and
outputting the predicted future state of the voltage grid.

One aspect provides that the first characteristic parameter and/or the second characteristic parameter is a voltage, a current, a power, a frequency, a distortion (total harmonic distortion—THD), a harmonic (up to the 50th harmonic), a reactive power and/or an energy value. The corresponding characteristic parameter may have been acquired respectively for each phase of a multiphase voltage grid, that is, e.g. for the phases L1 to L3.

A further aspect provides that the first characteristic parameter is acquired multiple times, so that a time sequence comprising more than two points in time of the first characteristic parameter is available, which is processed. Alternatively or additionally, the second quantity, in particular the second characteristic parameter, may also be acquired multiple times, so that a time sequence of the second quantity is available, which is processed. In this respect, the respective quantity, i.e. the first characteristic parameter or the second quantity, is acquired several times in chronological succession, in particular periodically, in order to obtain a time series or time sequence of the respective quantity in this way. Based on the appropriate time series or time sequence, the future state of the voltage grid is predicted. In other words, at least the historical behavior of the first characteristic parameter is acquired and taken into account in predicting the future state. This may also be performed correspondingly for the second quantity, for example the second characteristic parameter. For example, a change in the first characteristic parameter can be determined in this way, which, together with the change in the second quantity over time, is unique to a particular future [state] of the voltage grid. The change over time may be a subtle deterioration, but it may also generally be characteristic oscillations or progressions that would not initially have an informative value when viewed on their own. The change in the second quantity may, for example, be a different day, a changing weather situation, a change due to the timetable, a change in charging system usage or similar. The combined evaluation of the two quantities makes it possible to obtain information that is relevant to the future state of the voltage grid, provided that the quantities have a mutual influence.

According to one embodiment, the processor unit comprises an artificial intelligence which receives at least the first characteristic parameter acquired at the at least two different points in time as an input quantity and outputs the future state of the voltage grid as an output quantity. The artificial intelligence may have been trained to recognize the corresponding correlation of the values of the first characteristic parameter that have been acquired at the different points in time among each other and to learn about respective technical relationships in the voltage grid, as a result of which reliable or very accurate predictions regarding the future state of the voltage grid are possible.

The invention therefore also relates to a method of training an artificial intelligence for predicting a future state of a voltage grid. The method of training comprises the steps of:
providing a training data set for the artificial intelligence, which comprises at least a first characteristic parameter of the voltage grid at a first point in time, the first characteristic parameter of the voltage grid at a second point in time, and an actual state of the voltage grid at a third point in time, which is later in time than the first point in time and the second point in time;
feeding the first characteristic parameter at the first point in time and the first characteristic parameter at the second point in time into a processor unit which includes the artificial intelligence to be trained, wherein the processor unit including the artificial intelligence processes the first characteristic parameter acquired at the different points in time together and outputs a predicted future state of the voltage grid at the third point in time;
comparing the predicted future state of the voltage grid at the third point in time with the actual state of the voltage grid at the third point in time, which is part of the training data set, in order to determine a deviation between the predicted future state of the voltage grid at the third point in time and the actual state of the voltage grid at the third point in time; and
feeding back the deviation between the predicted future state of the voltage grid at the third point in time and the actual state of the voltage grid at the third point in time in order to adjust weighting factors of the artificial intelligence to be trained, if the deviation is outside a tolerance range.

The artificial intelligence can therefore be appropriately trained using at least one training data set which comprises the first characteristic parameter both at a first point in time and at a second point in time, in particular a corresponding time sequence or time series of the first characteristic parameter, as well as an actual future state of the voltage grid which is available at the third point in time, which in terms of time is after the points in time at which the first characteristic parameter was determined or acquired, that is, corresponding values of the first characteristic parameter. In particular, the first point in time and the second point in time do not coincide, so that the first characteristic parameter has been acquired at two different points in time, in particular the respective values of the first characteristic parameter.

In principle, when training the artificial intelligence, it may also be provided that the artificial intelligence does not output the state of the voltage grid at a discrete point in time, but at an interval that comprises the third point in time, i.e. predicts the future state of the voltage grid for a future period of time.

The respective tolerance range for the deviation may be predefined and/or specified by a user, for example as a percentage or variance.

Generally, an artificial intelligence trained by means of the method described above may be used to predict the future state of the voltage grid.

In other words, the processor unit comprises a trained artificial intelligence, in particular an artificial intelligence trained in accordance with the method described above.

A further aspect provides that the artificial intelligence includes at least one artificial neural network, for example an artificial recurrent neural network (RNN) or an artificial convolutional neural network (CNN). The artificial intelligence may include a long short-term memory (LSTM) network or a gated recurrent unit (GRU). Such neural networks allow a prediction of a state in the future based on time series and/or time sequences. Accordingly, the artificial intelligence learns from past data (historical data), with the artificial intelligence predicting the future state of the voltage grid.

In particular, a multidimensional vector is generated which comprises the first characteristic parameter at the different points in time, that is, the first characteristic parameter acquired at the at least two different points in time, the multidimensional vector being processed by the processor unit. The artificial neural network is therefore configured to process a multidimensional vector that comprises, for example, a plurality of points in time of the first characteristic parameter in order to predict the future state of the voltage grid in this way. In addition to the first characteristic parameter, the multidimensional vector may also comprise further quantities, for example at least one second quantity, in particular at several points in time. The second quantity may be a quantity obtained from a database or a second characteristic quantity of the voltage grid. For example, the multidimensional vector has a dimension of up to eight, so that the vector can include data of up to eight different characteristic parameters, for example information relating to the voltage, the current, the power, the frequency, the distortion, harmonics, the reactive power and/or the energy value. The further quantities in addition to the first characteristic quantity may, in principle, each be singular values or (also) corresponding time series or time sequences.

Furthermore, at least one future development over time of a characteristic parameter can be predicted as a future state of the voltage grid. The artificial intelligence can therefore predict, for example, a future voltage profile for a particular time interval. Likewise, artificial intelligence can predict a future current profile for the respective time interval. The time interval can be defined by a user so that predictions can be made for a targeted time interval. This is of particular interest if certain machines or devices that are connected within the voltage grid to be monitored have to be operated free of trouble within a defined period of time. The operator or grid operator therefore has an interest in making sure that no or only very minor disturbances to the voltage grid occur, at least during this period of time.

Generally, the future development over time of a characteristic parameter can be predicted, for example the future development over time of the previously acquired characteristic parameter. However, it is also possible to predict the future development over time of a characteristic parameter other than that which has been acquired and fed into the processor unit.

In addition, the invention achieves the object by means of a system for monitoring a voltage grid, the system including a processor unit which is configured to carry out one of the above-mentioned methods. The system may be a measuring and analyzing device which is incorporated in the voltage grid to be monitored, e.g. on a top-hat rail. The advantages mentioned above are therefore obtained for the system in an analogous manner.

In particular, the system may include a device, for example a measuring and/or evaluation device or a protection device such as a surge protection device (SPD), wherein the device includes the processor unit.

The system, in particular the device, may furthermore comprise at least one data transfer device, whereby the system, in particular the device, can communicate with further devices, for example, in particular receives data that is additionally used for evaluation and/or for prediction of the future state of the voltage grid. In addition, the output of the predicted future state of the voltage grid may be effected by means of the data transfer device, which is in the form of a communication interface, for example.

Furthermore, the invention provides a computer program which includes program code means for carrying out the steps of one of the aforementioned methods when the computer program is executed on a processor unit, for example the processor unit of the aforementioned system.

Furthermore, the invention provides a computer-readable data carrier having the computer program of the above-mentioned type stored thereon.

The advantages mentioned above are thus obtained in an analogous manner for the computer program and the computer-readable data carrier.

Further advantages and features of the invention will be apparent from the description below and from the drawings, to which reference is made and in which:

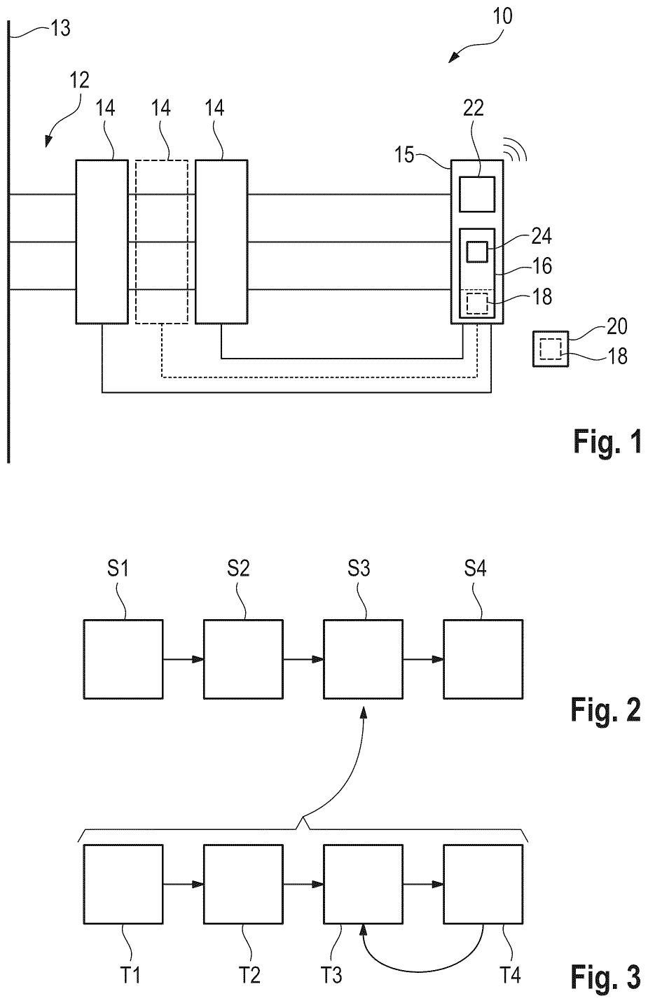

FIG. 1 shows a schematic illustration of a system according to the invention;

FIG. 2 shows an overview representing the method according to the invention for monitoring a voltage grid; and

FIG. 3 shows an overview representing the method according to the invention for training an artificial intelligence.

FIG. 1 shows a system 10 that monitors a voltage grid 12, which in the embodiment shown is a multiphase building grid that is connected to a supply grid 13. In this respect, the voltage grid 12 is a low-voltage grid, for example.

The system 10 comprises a plurality of measuring devices 14, which are connected in a signal-transmitting manner to a device 15, for example a protection device or a measuring and/or evaluation device. In the embodiment shown, both the measuring devices 14 and the device 15 are connected to or incorporated in the voltage grid 12 to be monitored. Alternatively, however, the device 15 may also be formed separately from the voltage grid 12, so that it is only connected to the measuring devices 14 in a signal-transmitting manner.

The device 15 comprises a processor unit 16, which is configured to execute a computer program 18 with program code means in order to monitor the voltage grid 12.

The computer program 18 may have been installed on the processor unit 16 from a computer-readable data carrier 20 which has the computer program 18 stored thereon, so that the system 10, in particular the device 15 including the processor unit 16, is able to carry out a respective method of monitoring the voltage grid 12.

Accordingly, the device 15 includes an appropriate interface via which the data carrier 20 can be coupled to the device 15 in order to install the computer program 18.

The computer program 18 may also have been transmitted via a data transfer device 22 which is, for example, in the form of a communication interface, for example for communication, in particular wireless communication, with the measuring devices 14 and/or a server. It may also be a LAN interface via which the communication of the device 15 is possible.

The method carried out by means of the computer program 18 will be discussed below with reference to FIG. 2.

In a first step S1, at least a first characteristic parameter of the voltage grid 12 is acquired at a first point in time. This may be performed by means of a first one of the measuring devices 14 or through the device 15 itself. In either case, it is ensured that the device 15, in particular its processor unit 16, acquires the first characteristic parameter of the voltage grid 12.

In a second step S2, the first characteristic parameter of the voltage grid 12 is acquired at a second point in time that is different from the first point in time.

Basically, the first characteristic parameter of the voltage grid 12 may be acquired at several points in time. The first characteristic parameter is thus acquired several times in chronological succession, in particular periodically, so that a time series/time sequence of the first characteristic parameter is available.

It may be supplementarily provided that at least a second quantity, for example a second characteristic parameter of the voltage grid 12, is acquired, which is different from the first characteristic parameter of the voltage grid 12. The second quantity may be acquired independently of the voltage grid 12, for example read out from a database to which the device 15 has access, in particular by means of the communication interface 22. From the database, data may be obtained which is included for analysis, for example environmental data such as weather data, time data (working day, weekend, public holiday, day and/or night) or usage data of systems in the surrounding area, for example a timetable for trains or usage data of electric charging systems in the surrounding area. This allows additional information to be obtained that explains any possible difference between the two values of the first characteristic parameter of the voltage grid 12 that were measured at the two points in time.

The second quantity obtained from the database is transferred to the processor unit 16 of the device 15, so that the processor unit 16 records the second quantity of the voltage grid 12.

But the second quantity may also be a second characteristic parameter of the voltage grid 12, which is acquired by one of the measuring devices 14 or by the device 15 itself, wherein the second characteristic parameter is transferred to the processor unit 16 of the device 15, so that the processor unit 16 acquires the second characteristic parameter of the voltage grid 12. If two characteristic parameters are determined, the two characteristic parameters differ from each other.

In principle, the first characteristic parameter of the voltage grid 12 may be a voltage, a current, a power, a frequency, a distortion, a harmonic, a reactive power and/or an energy value of the voltage grid 12, in particular of a phase of the multiphase voltage grid 12. This applies analogously to the second characteristic parameter, provided that the latter is additionally acquired.

As already mentioned above, a time series/time sequence of the first characteristic parameter of the voltage grid 12 is acquired. This may also apply to the optionally acquired second quantity.

For example, the second quantity is always also acquired when the first characteristic parameter of the voltage grid 12 is acquired, so that the values of the respective quantity or parameter are acquired in parallel, in particular at the same time.

This means in particular that when the first characteristic parameter of the voltage grid 12 is acquired at the different points in time, a corresponding data set is also read out from the database each time, which represents the second quantity, for example the weather data available at the respective points in time.

In a third step S3, at least the first characteristic parameter acquired at the first point in time and the first characteristic parameter acquired at the second point in time are fed into the processor unit 16, which processes the first characteristic parameter acquired at the first point in time and the first characteristic parameter acquired at the second point in time together, so that a future state of the voltage grid 12 is predicted by the processor unit 16 on the basis of the first characteristic parameter acquired at the at least two different points in time.

In addition, it may be provided that the second quantity acquired at least once, which is different from the first characteristic parameter of the voltage grid 12, is also processed together in order to predict the future state of the voltage grid 12 by the processor unit 16.

For prediction, the processor unit 16 includes an artificial intelligence 24, which receives at least the first characteristic parameter acquired at the at least two different points in time as an input quantity and outputs the future state of the voltage grid 12 as an output quantity.

The artificial intelligence 24 may comprise at least one artificial neural network, for example a convolutional neural network (CNN) or an artificial recurrent neural network (RNN), such as a long short-term memory (LSTM) network or a gated recurrent unit (GRU).

Accordingly, the artificial intelligence 24 is able to predict a future state of the voltage grid 12 on the basis of at least the time series obtained, that is, the time sequence of the first characteristic parameter. To this end, the artificial intelligence 24 processes the plurality of values of the first characteristic parameter that were acquired at different points in time in that it is generated as a multidimensional vector and processed by the artificial intelligence 24 accordingly.

The multidimensional vector includes, for example, up to eight dimensions, e.g. eight dimensions per phase of the multiphase voltage grid 12. The eight dimensions can be mapped correspondingly by the voltage, the current, the power, the frequency, the distortion, the harmonic, the reactive power and the energy value. Basically, however, the dimension of the vector may also be higher, depending on the application.

The artificial intelligence 24 may have been previously trained by means of a method in which the artificial intelligence 24 was trained to predict the future state of the voltage grid 12 based on values of the first characteristic parameter that were acquired at at least two different points in time. Therefore, the artificial intelligence 24 is a trained artificial intelligence 24.

The corresponding method of training the artificial intelligence 24 is shown in FIG. 3, to which reference is made below.

In a first training step T1, a training data set for the artificial intelligence 24 is provided, which comprises at least the first characteristic parameter of the voltage grid 12 at a first point in time, the first characteristic parameter of the voltage grid 12 at a second point in time, and an actual state of the voltage grid 12 at a third point in time. The third point in time here is later than the first point in time and the second point in time, so that it is a future point in time to be predicted, proceeding from the first point in time and the second point in time.

In addition, a second quantity may be contained in the training data set, which is different from the first characteristic parameter, so that the training data set comprises at least two different quantities. The second quantity may be a second characteristic parameter of the voltage grid 12 that is different from the first characteristic parameter.

In particular, the training data set may comprise a time series or time sequence of the first characteristic parameter, so that a plurality of values, preferably more than two values, of the first characteristic parameter are available, which were measured or acquired at different points in time.

The optionally provided second quantity may also be contained in the training data set as a time series or time sequence. The training data set may thus comprise data of at least two different quantities or parameters, in particular two different characteristic parameters of the voltage grid 12, for a particular time period as well as information on the state of the voltage grid 12 that was obtained at a later point in time than the particular time period.

But it is also possible for the training data set to comprise corresponding information of more than only two different quantities, in particular of more than two different characteristic parameters of the voltage grid 12, whereby more information or data is made available altogether, as a result of which the training is more comprehensive and the informational value of the correspondingly trained artificial intelligence 24 is higher.

In a second training step T2, at least the first characteristic parameter acquired at the first point in time and the first characteristic parameter acquired at the second point in time, in particular the time series or time sequence of the first characteristic parameter, are fed into the processor unit 16, which includes the artificial intelligence 24 to be trained. The processor unit 16 including the artificial intelligence 24 processes the first characteristic parameter acquired at the different points in time, in particular the time series or time sequence, together and outputs a predicted future state of the voltage grid 12 at the third point in time, at which the training data set comprises the actual state of the voltage grid 12.

Accordingly, during the training the artificial intelligence 24 learns respective relationships between the first characteristic parameter acquired at the two different points in time and its effect(s) on the later state of the voltage grid 12, so that the artificial intelligence 24 is trained to predict the future state of the voltage grid 12 on the basis of the past and/or current data.

In addition, the second quantity may optionally be incorporated, whereby correlations between the different quantities are recognized during training, that is, correlations between the values of the first characteristic parameter, which were acquired at the different points in time, and the second quantity, which was acquired once or also at the different points in time.

In a third training step T3, the predicted future state of the voltage grid 12 at the third point in time is compared with the actual state of the voltage grid 12 at the third point in time, wherein the latter was contained in the training data set. Using the comparison, a deviation between the predicted future state of the voltage grid 12 and the actual state of the voltage grid 12 is determined. In this respect, it is determined during the training how accurate the prediction made by the artificial intelligence 24 already is, i.e. how well the prediction matches the actual state.

In a fourth training step T4, the determined deviation between the predicted future state of the voltage grid 12 and the actual state of the voltage grid 12 is fed back into the artificial intelligence 24 to be trained, in order to adjust weighting factors of the artificial intelligence 24 to be trained, provided the deviation is outside a tolerance range. This is indicated by the corresponding arrow in FIG. 3. The tolerance range may be predefined here and/or may have been set by a user.

Subsequently, at least the training step T3 is repeated, with the deviation determined during the comparison in training step T3 being increasingly reduced. After a certain number of repetitions (iterations), the deviation is so small that the deviation is within the tolerance range so that the deviation is no longer fed back. The artificial intelligence 24 has then reached an at least (pre-) trained state for the training data set so that it can be used.

The artificial intelligence 24 may subsequently be further trained with the same training steps T1-T4 with the respective iterations, so that the artificial intelligence 24 is trained, for example, on further characteristic parameters of the voltage grid 12, in particular different pairings of characteristic parameters of the voltage grid 12.

In particular, the training of the artificial intelligence 24 may also comprise the feeding in of more than two different quantities, in particular characteristic parameters of the voltage grid 12, for example up to eight different quantities or more. The respective training set used for this purpose therefore includes more data, which is provided and fed in.

This means that typically the training steps T1 to T4 are repeated for a plurality of different actual states of the voltage grid 12 and/or a plurality of different data of the characteristic parameters, in particular for a plurality of different characteristic parameters, in order to train the artificial intelligence 24. As already described, in the final training step T4 the weighting factors of the artificial intelligence 24 to be trained are adjusted such that the respectively predicted future state of the voltage grid 12 is always within the tolerance range.

The artificial intelligence 24 used in the method of monitoring the voltage grid 12 has been trained in accordance with the above-mentioned training method, so that it is a trained artificial intelligence 24 which predicts the future state of the voltage grid 12 based on at least two values of the first characteristic parameter that have been acquired at different points in time.

Accordingly, the processor unit 16, which comprises the trained artificial intelligence 24, outputs the predicted future state of the voltage grid 12 in a fourth step S4.

This may be a development over time of a characteristic parameter of the voltage grid 12, in particular a characteristic parameter that is different from the first characteristic parameter (and the second characteristic parameter). For example, the artificial intelligence 24 is configured, inter alia, to predict the future course of a total harmonic distortion (THD) of the voltage grid 12, this being effected on the basis of the historical data (time series or time sequences) of the current and/or the voltage.

Basically, it is therefore possible for a grid operator and/or an electricity customer or electricity user to identify future disturbances or phases of weakness in the voltage grid 12 in a timely manner and to initiate appropriate countermeasures in order to stably operate the voltage grid 12.

1. A method of monitoring a voltage grid (12), comprising the steps of:
acquiring at least a first characteristic parameter of the voltage grid (12) at a first point in time;
acquiring the first characteristic parameter of the voltage grid (12) at a second point in time that is different from the first point in time;
feeding the first characteristic parameter acquired at the first point in time and the first characteristic parameter acquired at the second point in time into a processor unit (16), which processes the first characteristic parameter acquired at the first point in time and the first characteristic parameter acquired at the second point in time together such that a future state of the voltage grid (12) is predicted on the basis of the first characteristic parameter acquired at the at least two different points in time; and
outputting the predicted future state of the voltage grid (12).

2. The method according to claim 1, characterized in that the first characteristic parameter is a voltage, a current, a power, a frequency, a distortion, a harmonic, a reactive power and/or an energy value, in particular for a phase of a multiphase voltage grid (12).

3. The method according to claim 1, characterized in that the first characteristic parameter is acquired multiple times, so that a time sequence comprising more than two points in time of the first characteristic parameter is available, which is processed.

4. The method according to claim 1, characterized in that the processor unit (16) comprises an artificial intelligence (24) which receives at least the first characteristic parameter acquired at the at least two different points in time as an input quantity and outputs the future state of the voltage grid (12) as an output quantity.

5. The method according to claim 4, characterized in that the artificial intelligence (24) includes at least one artificial neural network, for example an artificial convolutional neural network or an artificial recurrent neural network, in particular wherein the artificial intelligence includes a long short-term memory (LSTM) network or a gated recurrent unit (GRU).

6. The method according to claim 1, characterized in that a multidimensional vector is generated which comprises the first characteristic parameter acquired at the at least two different points in time, the multidimensional vector being processed by the processor unit (16).

7. The method according to claim 1, characterized in that at least one future development over time of a characteristic parameter is predicted as the future state of the voltage grid (12).

8. A method of training an artificial intelligence (24) for predicting a future state of a voltage grid (12), comprising the steps of:
providing a training data set for the artificial intelligence (24), which comprises at least a first characteristic parameter of the voltage grid (12) at a first point in time, the first characteristic parameter of the voltage grid (12) at a second point in time, and an actual state of the voltage grid (12) at a third point in time, which is later in time than the first point in time and the second point in time;
feeding the first characteristic parameter at the first point in time and the first characteristic parameter at the second point in time into a processor unit (16) which includes the artificial intelligence (24) to be trained, wherein the processor unit (16) including the artificial intelligence (24) processes the first characteristic parameter acquired at the different points in time together and outputs a predicted future state of the voltage grid (12) at the third point in time;
comparing the predicted future state of the voltage grid (12) at the third point in time with the actual state of the voltage grid (12) at the third point in time, which is part of the training data set, in order to determine a deviation between the predicted future state of the voltage grid (12) at the third point in time and the actual state of the voltage grid (12) at the third point in time; and
feeding back the deviation between the predicted future state of the voltage grid (12) at the third point in time and the actual state of the voltage grid (12) at the third point in time in order to adjust weighting factors of the artificial intelligence (24) to be trained, if the deviation is outside a tolerance range.

9. A system (10) for monitoring a voltage grid (12), comprising at least one processor unit (16) configured to carry out a method according to claim 1.

10. A computer program (18) comprising program code means for carrying out the steps of a method according to claim 1 when the computer program (18) is executed on a processor unit (16).

11. A computer-readable data carrier (20) having the computer program (18) according to claim 10 stored thereon.
